(19) United States
(12) Patent Application Publication
(10) Pub. No.: US 2005/0209086 A1
(43) Pub. Date: Sep. 22, 2005

(54) Panel glass for cathode ray tube

(75) Inventors: Tsunehiko Sugawara, Tokyo (JP); Mitsuyoshi Sakai, Hyogo (JP); Ryosuke Akagi, Hyogo (JP); Yoshinori Hatakenaka, Hyogo (JP); Hiroshi Kaneko, Hyogo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Asahi Glass Company, Limited, Tokyo (JP)

(21) Appl. No.: 11/008,172

(22) Filed: Dec. 10, 2004

(30) Foreign Application Priority Data
Dec. 10, 2003 (JP) 2003-411247

(51) Int. Cl. C03C 3/078; C03C 3/085

(52) U.S. Cl. 501/72; 501/69

(57) ABSTRACT

To provide a novel glass composition having the property of browning substantially improved, while securing an adequate X-ray absorption property and while suppressing devitrification of a panel glass to a practically problem-free level, in preparation for higher voltage and larger current for projection type cathode ray tubes.

A panel glass for cathode ray tube, having a glass composition containing substantially no PbO, and more than 10 mass % and at most 15 mass % of ZnO, wherein (MgO (mass %)+ZnO (mass %))/(SrO (mass %)+BaO(mass %)+CaO (mass %))>0.55, and wherein when the sum of Na₂O (mol %), K₂O (mol %) and Li₂O (mol %), as represented by mol percentage, is represented by R₂O, 0.15≦Na₂O (mol %)/R₂O≦0.25, and 0.45≦K₂O (mol %)/R₂O≦0.55, and the linear absorption coefficient of X-ray having a wavelength of 0.06 nm is at least 36.0 cm⁻¹.

### BACKGROUND OF THE INVENTION

1. Field of the Invention

The present invention relates to a panel glass for cathode ray tube to be used primarily for a projection-type color television.

2. Discussion of Background

The envelope of a cathode ray tube is constituted by a glass panel and a glass funnel. The glass panel comprises a face portion having an effective screen coated with a fluorescent material approximately in a rectangular shape, and a skirt portion formed substantially perpendicular to the face portion. The end portion of the skirt portion constitutes an opening. Whereas, the glass funnel has a funnel shape, and its opening having a large diameter has substantially the same shape as the opening of the above glass panel, and it has a neck portion to accommodate an electron gun at its opening having a small diameter.

In this specification, a glass material to be used for forming the glass panel, will be referred to as “panel glass”.

As color televisions employing such a cathode ray tube, a television provided with a projection type cathode ray tube (hereinafter referred to as a projection type television) and a television provided with a direct-view-type cathode ray tube (hereinafter referred to as a direct-view-type television) are known.

The direct-view-type television is one designed to have the above fluorescent material irradiated with an electron beam emitted from the electron gun, to form an image on the face portion itself, while the projection-type television is one designed to have an image transmitted through the face portion, projected on a wall or on a projection screen.

Accordingly, in the case of the projection-type television, the area of the image projected on a projection screen or the like will reach a level of about 100 times the area of the image formed on the outer surface of the face portion of the projection-type cathode ray tube. Accordingly, if the brightness of the image on the outer surface of the face portion of the projection-type cathode ray tube is at the same level as the brightness of the direct-view-type cathode ray tube, it will be substantially low when projected as enlarged.

As a measure to cope with the shortage of brightness of the projection type cathode ray tube, it is common to adjust the electric power input to the screen of the projection-type cathode ray tube to be about 100 times, as compared with the direct-view-type cathode ray tube. Namely, the brightness is secured by adjusting the anode voltage to a maximum level of from about 30 to 34 kV and adjusting the anode current to a maximum level of from about 2 to 6 mA.

Further, the transmittance in a visible light region of the glass panel is made to be as high as possible in order to minimize the loss of emitted light when it passes through the glass panel. However, when electron beams are irradiated at such high voltage and large current, the proportion of electrons which will readily pass through a fluorescent material layer having a thickness of from a few μm to a few tens μm and penetrate into and accumulate in the glass without contributing to light emission of the fluorescent material, will increase.

The depth of such penetration of electron beams will reach to a level of a few μm from the surface on the fluorescent material side of the glass panel. At the region where the electron beams have penetrated, the panel glass will be colored brown, i.e. so-called browning will be remarkable as compared with the direct-view-type cathode ray tube. The browning phenomenon will progress as the irradiation time of electron beams will be prolonged, and consequently, the transmittance of the panel glass gradually decreases. Namely, the projection-type cathode ray tube operated for a long time, has a problem that the brightness is deteriorated substantially as compared with the initial state of the product.

As a method for inhibiting browning, Japanese Patent 2,645,286 (Patent Document 1) proposes a method wherein ZnO is excluded from the composition of a panel glass, and in order to maintain the necessary X-ray absorption property, instead of ZnO, at least a part thereof is substituted by additional SrO.

JP-A-8-277140 (Patent Document 2) states that movement of alkali metal ions is the main cause for browning, and accordingly, a glass composition containing no alkali metal or a glass containing an alkali metal having low mobility is most suitable as a panel glass for a projection-type cathode ray tube. Specifically, it discloses a glass composition which basically does not contain ZnO, PbO and other readily reducible metal oxides, other than Sb₂O₃, and which contain oxides in the following weight percent as components:

| | |
|---|---|
| SiO₂ | 55 to 60 |
| K₂O | 5.75 to 10 |
| Al₂O₃ | 1 to 3 |
| Na₂O + K₂O | 10.5 to 14 |
| ZrO₂ | 0 to 3.5 |
| K₂O/Na₂O (weight ratio) | 1.6 to 2.6 |
| LiO₂ | 0.6 to 2 |
| K₂O/Na₂O (molar ratio) | >1 |
| SrO | 7.5 to 13.5 |
| CeO₂ | 0.5 to 1 |
| BaO | 14 to 16 |
| TiO₂ | 0.25 to 1 |
| Na₂O | 3 to 5 |
| Sb₂O₃ | 0.15 to 0.5. |

Japanese Patent 3,007,653 (Patent Document 3) proposes a glass composition wherein as a component to inhibit browning by electron beam, Li₂O is incorporated in an amount of more than 0.5%, and further, to inhibit browning, Na₂O wt %/(Na₂O wt %+K₂O wt %) is required to be from 0.06 to 0.24, and Na₂O is required to be at most 2.9%.

JP-A-2003-137596 (Patent Document 4) proposes a method for preventing alkali metal ions from becoming a colloid by adjusting the molar composition ratios of Na₂O/R₂O (R₂O:Na₂O+K₂O+Li₂O), K₂O/R₂O and Li₂O/R₂O to be within a region defined by point A (0, 0.2, 0.8), point B (0.2, 0.2, 0.6), point C (0.4, 0.6, 0), point D (0.2, 0.8, 0) and point E (0, 0.4, 0.6), of a ternary composition diagram.

These methods are generally designed not to incorporate readily reducible oxides taking into a damage of the glass structure into consideration or seek for conditions whereby alkali ions tend to hardly be movable taking into consideration the possibility of movable alkali ions to be attracted and reduced by accumulated electrons. However, as a panel glass for a projection type cathode ray tube, none of them was a sufficient glass composition with a view to inhibiting browning to comply with the requirement for higher voltage and larger current in recent years.

On the other hand, in the case of a projection-type cathode ray tube, electron beams with high voltage and large current, are employed, whereby X-rays will be substantially generated when the electron beams impinge on the fluorescent material film to excite the fluorescent material. Accordingly, with a view to securing safety to a human body, the glass envelope is required to have a sufficient X-ray absorption capability as its function, so that the generated X-rays will not leak to the exterior.

In order to increase the X-ray absorption capability, a heavy metal oxide may be added to the glass composition. However, if PbO is incorporated, electrons penetrated into the glass will reduce lead oxide, whereby the glass will readily be colored. Therefore, in a panel glass for cathode ray tube, it is common to have a glass composition which does not contain PbO and instead, contains a bivalent metal oxide such as SrO, BaO or ZnO, as shown in U.S. Pat. No. 3,464,932 (Patent Document 5) or many other patent documents.

A glass panel to be used for a cathode ray tube is usually molded by a press molding method into an approximately box type three dimensional shape. In order to carry out such molding constantly, it is necessary to supply a constant amount of a molten glass mass (hereinafter referred to as a gob) at a constant temperature into a mold. For this purpose, the temperature is controlled by using as an index the temperature (the gob temperature) at the time when the viscosity of glass during the supply becomes to be about 102.7 Pa·S. Accordingly, a composition whereby the glass devitrifies in the vicinity of the gob temperature, is not practical. Namely, the devitrification temperature is preferably lower than the gob temperature, and the larger the difference the better.

If the above-mentioned bivalent metal oxide, or MgO or ZrO₂, is incorporated in a large amount in glass, the glass tends to devitrify, and there will be a problem such that the liquidized temperature rises. Accordingly, a method for controlling the devitrification by limiting the content of ZnO or ZrO₂, is disclosed in JP-A-63-215533 (Patent Document 6) or JP-A-3-12337 (Patent Document 7).

On the other hand, JP-A-2001-302277 (Patent Document 8) discloses a method for controlling the devitrification by adjusting the ratio of SrO/(SrO+BaO) to be within a range of from 0.30 to 0.45, while suppressing ZnO to a level of at most 8%. The above-mentioned Patent Document 4 discloses a method for controlling the devitrification by adjusting the ratio of SrO/(SrO+BaO) to be within a range of from 0.35 to 0.70, while adjusting ZnO to be within a range of from 5 to 10%.
Patent Document 1: Japanese Patent 2,645,286
Patent Document 2: JP-A-8-0277140
Patent Document 3: Japanese Patent 3,007,653
Patent Document 4: JP-A-2003-137596
Patent Document 5: U.S. Pat. No. 3,464,932
Patent Document 6: JP-A-63-215533
Patent Document 7: JP-A-3-12337
Patent Document 8: JP-A-2001-302277

As described in the foregoing, many glass compositions have been proposed as means to inhibit browning of a panel glass to be used for a projection type cathode ray tube to be operated at a high voltage and large current. However, in recent years, in order to maintain the superiority in brightness to a projection-type television employing liquid crystal, higher voltage and larger current for a cathode ray tube are in progress.

Namely, by conventional methods, inhibition of browning of a panel glass tends to be inadequate, and a glass composition having a more effective inhibitory effect of browning is desired. While there has been a specific disclosure of a method for optimizing an alkali metal oxide or exclusion of highly reducible lead oxide, there has been no specific disclose with respect to a method for inhibiting browning in a case where a metal oxide comprising bivalent metal ions, is incorporated in a large amount in order to increase the X-ray absorption capability to comply with the higher voltage and larger current.

On the other hand, in a case where a bivalent metal oxide is incorporated in a large amount, a devitrification problem is likely to result at the time of molding a glass panel after melting the glass, and it is practically indispensable to have a solution in this connection. As mentioned above, some methods have been proposed to control the devitrification by paying an attention only to the ratio of SrO and BaO. However, such is not one which optimizes the contents with respect to all bivalent metal oxides including ZnO and MgO which present substantial influences over the devitrification. In particular, there has been no specific method for controlling devitrification with respect to a system wherein ZnO is contained in an amount larger than 10% (mass percentage).

Further, there has been no specific proposal based on the relation with the gob temperature, and the conventional proposal is based only on the degree of the devitrification temperature (liquidized temperature), such being poor in practical applicability.

### SUMMARY OF THE INVENTION

It is an object of the present invention to provide a novel glass composition having the browning property substantially improved while securing an adequate X-ray absorption capability and while controlling the devitrification of the panel glass to be used for a cathode ray tube to a practically problem-free level to comply with the higher voltage and larger current of a projection-type cathode ray tube.

To solve the above problems, the present invention provides a panel glass for cathode ray tube, having a glass composition containing substantially no PbO, wherein the contents of the respective components based on their oxides, as represented by mass percentage, are:

```
48 ≦ SiO₂ (mass %) ≦ 60,
  0 ≦ Al₂O₃ (mass %) ≦ 2.5,
  0 ≦ MgO (mass %) ≦ 2,
  0 ≦ CaO (mass %) ≦ 3,
  7 ≦ SrO (mass %) ≦ 10,
10 ≦ BaO (mass %) ≦ 15,
10 ≦ ZnO (mass %) ≦ 15,
  1 ≦ Na₂O (mass %) ≦ 5,
  7 ≦ K₂O (mass %) ≦ 11,
0.5 ≦ Li₂O (mass %) ≦ 3,
  0 ≦ ZrO₂ (mass %) ≦ 2.5,
  0 ≦ TiO₂ (mass %) ≦ 2,
  0 ≦ CeO₂ (mass %) ≦ 1,
  0 ≦ Sb₂O₃ (mass %) ≦ 0.5, and
```

(MgO (mass %)+ZnO (mass %))/(SrO (mass %)+BaO(mass %)+CaO (mass %))>0.55, and wherein when the sum of Na₂O (mol %), K₂O (mol %) and Li₂O (mol %), as represented by mol percentage, is represented by R₂O, 0.15≦Na₂O (mol %)/R₂O≦0.25, and 0.45≦K₂O (mol %)/R₂O≦0.55, and
the linear absorption coefficient of X-ray having a wavelength of 0.06 nm is at least 36.0 cm⁻¹.

The present inventors have conducted various experiments and as a result, have found a glass composition which is practically free from a problem of devitrification, while securing an adequate X-ray absorption capability and increasing the inhibitory power against browning by electron beams than ever.

Namely, they have found a practical glass composition range which has a sufficient inhibitory effect against browning, which can not be accomplished merely by seeking the optimum range of the content of the alkali oxides, by simultaneously optimizing the contents of bivalent metal oxides. Further, mentioning specifically about the optimization of the contents of bivalent metal oxides, they have found that rather than SrO, BaO and CaO, ZnO and MgO having larger electronegativity, have higher inhibitory effects against browning, and they have found the optimum ranges of the contents of bivalent metal oxides not departing from the practical range of devitrification or from the relation with the gob temperature, while securing the X-ray absorption capability.

The panel glass for cathode ray tube of the present invention has a high X-ray absorption coefficient, scarcely undergoes browning by X-rays or electron beams and secures a practical range of devitrification, whereby melt-molding is easy, and it is particularly suitable as a panel glass for cathode ray tube to be used for a color television.

### DETAILED DESCRIPTION OF THE PREFERRED EMBODIMENTS

Now, the present invention will be described in detail with reference to the preferred embodiments. In the description of the present invention, the content of each component will be shown by adding (mass %) after the chemical formula of the component like SiO₂ (mass %) in a case where it is represented by mass percentage. Further, when it is represented by mol percentage, (mol %) will be added after the chemical formula of the component like Na₂O (mol %).

SiO₂

SiO₂ is a network former of the panel glass for cathode ray tube of the present invention. By adjusting the content of SiO₂ to be at least 48 mass %, the shortage of viscosity of the gob can be solved, and at the same time, chemical durability can be secured. Further, by adjusting it to be at most 60%, the moldability can be improved without increasing the viscosity too much. The content of SiO₂ is more preferably 50≦SiO₂(mass %)≦57 from the viewpoint of the chemical durability, most preferably 51≦SiO₂(mass %)≦55 from the viewpoint of both the moldability and the chemical durability.

Al₂O₃

Al₂O₃ is incorporated to improve the water resistance of the panel glass for cathode ray tube of the present invention. By adjusting the content of Al₂O₃ to be at most 2.5 mass %, the devitrification will be suppressed, and at the same time the moldability can be improved without increasing the viscosity of glass too much. The content of Al₂O₃ is more preferably 0≦Al₂O₃(mass %)≦2 from the viewpoint of improvement of the moldability, most preferably 0≦Al₂O₃(mass %)≦1 from the viewpoint of improvement of the moldability and suppression of the devitrification.

MgO

Together with the after-mentioned ZnO, MgO has an effect to inhibit browning by electron beams. Even if the content of MgO increases beyond 2 mass %, no remarkable effect will be obtained with respect to inhibition of browning by electron beams. Whereas, by adjusting it to be at most 2 mass %, the shortage of viscosity can be solved, and suitable moldability can be secured, and at the same time, the devitrification can suitably be suppressed, and accordingly, it is adjusted to be 0≦MgO(mass %)≦2. The content of MgO is more preferably 0≦MgO(mass %)≦1 from the viewpoint of improvement of the moldability, most preferably 0≦MgO(mass %)≦0.5 from the viewpoint of improvement of the moldability and suppression of the devitrification.

CaO

CaO is a component to primarily adjust the viscosity curve of the panel glass for cathode ray tube of the present invention, and when it is at most 3 mass %, the glass will have a proper viscosity, whereby desired moldability can be obtained. The content of CaO is more preferably 0≦CaO(mass %)≦2 from the viewpoint of improvement of the moldability, most preferably 0≦CaO(mass %)≦1 from the viewpoint of improvement of the moldability and suppression of the devitrification.

SrO

SrO is incorporated in an amount of at least 7 mass % as a network modifier of the panel glass for cathode ray tube of the present invention and in order to increase the X-ray absorption capability of the glass. Further, by adjusting the content of SrO to be at most 10%, precipitation of crystal of BaO—SrO—SiO₂ type is suppressed. The content of SrO is more preferably 7≦SrO(mass %)≦9 from the viewpoint of suppression of the devitrification, most preferably 7≦SrO(mass %)≦8 from the viewpoint of suppression of the devitrification and improvement of the X-ray absorption capability.

BaO

Like the above-mentioned SrO, BaO is incorporated in an amount of at least 10 mass % as a network modifier for the panel glass for cathode ray tube of the present invention and in order to increase the X-ray absorption capability of the glass. Further, by adjusting the content of BaO to be at most 15 mass %, precipitation of crystal of BaO—SrO—SiO₂ type is suppressed. The content of BaO is more preferably 11≦BaO(mass %)≦14 from the viewpoint of the X-ray absorption capability, most preferably 11≦BaO(mass %)≦12.5 from the viewpoint of suppression of the devitrification and improvement of the X-ray absorption capability.

ZnO

ZnO is incorporated in an amount exceeding 10 mass % in order to increase the X-ray absorption capability of the panel glass for cathode ray tube of the present invention and to inhibit browning by electron beams. Further, by adjusting the content of ZnO to be at most 15 mass %, devitrification of the glass can be suppressed. The content of ZnO is more preferably ZnO(mass %)≦14 from the viewpoint of suppression of the devitrification, most preferably 11≦ZnO(mass %) from the viewpoint of inhibition of browning by electron beams and suppression of the devitrification.

Li₂O

When permitted to be coexistent with the after-mentioned Na₂O and K₂O, Li₂O has an effect to inhibit browning by electron beams and to increase the electric resistance by the mixed alkali effect. Further, it is also a component to improve the melting property of glass and to increase the thermal expansion coefficient. To obtain such effects, Li₂O is incorporated in an amount of at least 0.5 mass %. Further, by adjusting it to be at most 3.0 mass %, devitrification of glass can be reduced. Further, the raw material of Li₂O is expensive, and it is not desired to be incorporated in a large amount from the viewpoint of the cost. The content of Li₂O is more preferably 0.5≦Li₂O(mass %)≦2 from the viewpoint of the cost, most preferably 1≦Li₂O(mass %)≦2 from the viewpoint of inhibition of browning by electron beams.

Na₂O

Na₂O is a component to adjust the thermal expansion coefficient and the viscosity. When Na₂O is incorporated in an amount of at least 1 mass %, the panel glass for cathode ray tube of the present invention will have a proper thermal expansion coefficient, which will coincide with the thermal expansion coefficient of a funnel glass. Further, by adjusting the content of Na₂O to be at most 5 mass %, the shortage of viscosity will be solved, and molding will be easy. The content of Na₂O is more preferably 1.5≦Na₂O(mass %)≦3.5 from the viewpoint of improvement of the moldability, most preferably 2≦Na₂O(mass %)≦3 from the viewpoint of optimization of the thermal expansion coefficient and improvement of the moldability.

K₂O

K₂O is a component to adjust the thermal expansion coefficient and the viscosity like the above-mentioned Na₂O. By adjusting the content of K₂O to be at least 7%, an excessive increase of the viscosity of glass will be suppressed, whereby the molding will be easy, and by adjusting it to be at most 11%, it is possible to prevent the possibility that the thermal expansion coefficient of glass tends to be too high. The content of K₂O is more preferably 8≦K₂O(mass %)≦10 from the viewpoint of improvement of the moldability, most preferably 8.5≦K₂O(mass %)≦9.5 from the viewpoint of optimization of the thermal expansion coefficient and improvement of the moldability.

ZrO₂

ZrO₂ is incorporated to increase the X-ray absorption coefficient of the panel glass for cathode ray tube of the present invention. By adjusting the content of ZrO₂ to be at most 2.5%, the surface devitrification temperature between the glass and the refractory will be lowered, whereby devitrification at the surface tends to scarcely take place. Namely, by lowering the surface devitrification temperature, the appearance of the glass panel employing the panel glass for cathode ray tube of the present invention, will be improved, and the productivity will be improved. The content of ZrO₂ is more preferably 0.5≦ZrO₂(mass %)≦2 from the viewpoint of improvement of the X-ray absorption capability and suppression of the devitrification, most preferably 0.5≦ZrO₂(mass %)≦1 from the viewpoint of further suppression of the devitrification.

TiO₂

TiO₂ is incorporated to prevent coloration of the panel glass for cathode ray tube of the present invention by ultraviolet rays and X-rays. By adjusting the content of TiO₂ to be at most 2%, the ultraviolet transmittance or the X-ray transmittance can be brought to be within a proper range. The raw material of TiO₂ is expensive, and it is not desirable to be incorporated in a large amount from the viewpoint of the cost. The content of TiO₂ is more preferably 0≦TiO₂(mass %)≦1.5 from the viewpoint of the prevention of coloration of the panel glass for cathode ray tube of the present invention by ultraviolet rays and X-rays.

CeO₂

CeO₂ provides an effect to prevent coloration of the panel glass for cathode ray tube of the present invention by X-rays and an effect as a fining agent. By adjusting the content of CeO₂ to be at most 1%, devitrification can be suppressed, and decrease of the optical transmittance in a visible short wavelength region can be suppressed. From the viewpoint of inhibition of browning by X-rays, the content of CeO₂ is more preferably 0.3≦CeO₂(mass %)≦0.7, most preferably 0.4≦CeO₂(mass %)≦0.6.

Sb₂O₃

Sb₂O₃ is incorporated as a fining agent of the panel glass for cathode ray tube of the present invention. By adjusting it to be at most 0.5%, it is possible to suppress the remarkable surface devitrification of glass. With a view to suppressing the devitrification, the content of Sb₂O₃ is more preferably 0≦Sb₂O₃(mass %)≦0.4, most preferably 0≦Sb₂O₃(mass %)≦0.2.

Other components

In the panel glass for cathode ray tube of the present invention, a coloring component such as NiO, CO₃O₄ or Fe₂O₃ to lower the transmittance of glass or to adjust the coloration, may be added in addition to the above-described components. However, PbO should not be incorporated, since if it is contained, reduction of PbO itself will be led, and coloration due to browning by X-rays and electron beams tends to result. In the panel glass for cathode ray tube of the present invention, “contains substantially no PbO” means that PbO is not intentionally contained except for a case where it is contained as an impurity in the raw material.

The Content Ratio of the Respective Components

Further, by adjusting the ratio of (MgO(mass %)+ZnO(mass %))/(SrO(mass %)+BaO(mass %)+CaO(mass %)) to be larger than 0.55, it is possible to increase the inhibitory effect against browning by electron beams. The value of the above-mentioned ratio of (MgO(mass %)+ZnO(mass %))/(SrO(mass %)+BaO(mass %)+CaO(mass %)) is more preferably at least 0.58, most preferably at least 0.7.

Further, in order to effectively inhibit browning by electron beams, when the sum of the molar percentages of Na₂O (mol %), K₂O (mol %) and Li₂O (mol %) is represented by R₂O, 0.15≦Na₂O(mol %)/R₂O≦0.25, and 0.45≦K₂O(mol %)/R₂O≦0.55. The value of Na₂O(mol %)/R₂O is more preferably from 0.17 to 0.22, most preferably from 0.18 to 0.21. Further, the value of K₂O(mol %)/R₂O is more preferably from 0.48 to 0.54, most preferably from 0.49 to 0.53.

Further, the panel glass for cathode ray tube of the present invention is characterized in that the respective components have the above-mentioned contents, and the linear absorption coefficient of X-ray at a wavelength of 0.06 nm (hereinafter referred to also as the X-ray absorption coefficient) is at least 36.0 cm⁻¹. If the above X-ray absorption coefficient is less than 36.0 cm¹, the X-ray absorption capability of glass tends to be low, whereby X-ray will leak to the exterior, and there may be a case where an influence to a human body be worried.

Now, the panel glass for cathode ray tube of the present invention will be described in further detail with reference to Examples. Firstly, the mass absorption coefficient W(cm²/g) and the electronegativity of each component (oxide), are shown in Table 1. (Reference literature: L-Pauling, “The Nature of the Chemical Bond”, 3rd ed., Conrnell Univ. Press (1960)).

TABLE 1

| | Mass absorption | |
|---|---|---|
| | coefficient | |
| | W(cm²/g) | Electronegativity |
| SiO₂ | 2.34 | 1.8 |
| Al₂O₃ | 2.11 | 1.5 |
| MgO | 1.92 | 1.2 |
| CaO | 8.81 | 1.0 |
| SrO | 53.4 | 1.0 |
| BaO | 25.1 | 0.9 |
| ZnO | 28.5 | 1.6 |
| Na₂O | 1.69 | 0.9 |
| K₂O | 8.45 | 0.8 |
| Li₂O | 0.55 | 1.0 |
| ZrO₂ | 53.5 | 1.4 |
| TiO₂ | 9.12 | 1.5 |
| CeO₂ | 25.3 | 1.2 |
| Sb₂O₃ | 18.2 | 1.9 |

Further, Table 2 shows Examples of the present invention (Sample Nos. 1 to 4), and Table 3 shows Comparative Examples (Sample Nos. 5 to 9). In Tables 2 and 3, “(MgO+ZnO)/(SrO+BaO+CaO)” represents “(MgO(mass %)+ZnO(mass %))/(SrO(mass %)+BaO(mass %)+CaO(mass %))”.

The respective samples in the Tables were prepared as follows. Firstly, a glass batch prepared by mixing the respective components to have the contents as shown in the Tables, was put into a platinum crucible, and the raw material was introduced at about 1,400° C. and melted at 1,480° C. for 80 minutes. Here, in order to obtain homogeneous glass, defoaming was carried out with stirring for 30 minutes by means of a platinum stirrer during the temperature rise or lowering of the molten glass. Thereafter, the molten glass was molded into a prescribed shape, followed by annealing. With respect to the respective samples No. 1 to 9 thus obtained, measurements of the X-ray absorption coefficients, the degrees of browning, the gob temperatures and the devitrification temperatures, were carried out, and the results are shown in Tables 2 and 3.

Here, the X-ray absorption coefficient is one obtained by calculating the linear absorption coefficient against X-ray having a wavelength of 0.06 nm. The mass absorption coefficient of each oxide is as shown in Table 1. The X-ray absorption coefficient μ(cm⁻¹) is a value calculated by the following mathematical formula (a), when the glass composition having a density ρ (g/cm³) is constituted by n types of components, and the contents as oxides of the respective components are from f₍₁₎ to f₍ₙ₎ (mass %), and the mass absorption coefficients as oxides of the respective components are W₍₁₎ to W₍ₙ₎ (cm²/g), respectively. Further, in the present invention, the X-ray absorption coefficient means the linear absorption coefficient of X-ray having a wavelength of 0.06 nm unless otherwise specified.

$$μ = ρ {\sum }_{i = 1}^{n} ( \frac{{f}_{( i )}}{100} \times {W}_{( i )} ) \qquad ( a )$$

For the property of browning by electron beams, “the relative degree of browning” is determined as follows.

Firstly, each sample is cut into a square of about 10 mm×10 mm, and both sides thereof are subjected to optical mirror polishing to bring the thickness to 3 mm, whereupon the spectral transmittance at a wavelength of from 400 nm to 700 nm is measured, and aluminum is vapor-deposited. Then, while maintaining the temperature of cooling water of the sample table at 80° C., electron beams of 20 μA/cm² at 30 kV are irradiated for 300 hours. Thereafter, the spectral transmittance at from 400 nm to 700 nm is measured, and from the decrease in the optical transmittance by irradiation with electron beams, the color difference is determined.

Thereafter, with respect to the color differences of the respective samples, the relative values are calculated, on the basis that the color difference of Sample No. 6 (Comparative Example) is taken as 1, and such a value is taken as “the relative degree of browning” representing the property of browning by electron beams. Namely, the larger the relative degree of browning, the larger the color difference, i.e. the decrease in the optical transmittance is large, thus indicating that browning by electron beams is substantial.

The gob temperature was measured by the measuring method prescribed in ISO/DIS 7884/2 as the temperature where the viscosity became 10^{2.7} Pa·s.

The devitrification temperature was measured as follows. Firstly, each sample was pulverized to a size of about 15 mm and mixed, and this mixture was put into a 400 mm platinum boat, which was transferred to a temperature gradient furnace of from 800 to 1,200° C. and maintained for 168 hours, whereupon the platinum boat was taken out from the temperature gradient furnace. Then, the glass was taken out from the platinum boat. The sample thus obtained was observed by a polarizing microscope, whereby the temperature at which crystals precipitated, was taken as the devitrification temperature.

TABLE 2

| | Sample No. (Examples) | | | |
|---|---|---|---|---|
| | 1 | 2 | 3 | 4 |
| SiO₂ (mass %) | 54.7 | 52.2 | 51.8 | 48.5 |
| Al₂O₃ (mass %) | 0.3 | 0.3 | 0.3 | 1.8 |
| MgO (mass %) | 0.0 | 0.0 | 0.0 | 1.6 |
| CaO (mass %) | 0.0 | 0.0 | 0.0 | 0.0 |
| SrO (mass %) | 7.5 | 7.2 | 7.3 | 7.7 |
| BaO (mass %) | 12.3 | 12.2 | 12.1 | 12.7 |
| ZnO (mass %) | 11.4 | 13.8 | 14.8 | 13.6 |
| Na₂O (mass %) | 2.0 | 2.2 | 2.0 | 2.2 |
| K₂O (mass %) | 8.8 | 9.1 | 8.8 | 8.9 |
| Li₂O (mass %) | 1.6 | 1.6 | 1.6 | 1.6 |
| ZrO₂ (mass %) | 0.5 | 0.5 | 0.5 | 0.5 |
| TiO₂ (mass %) | 0.2 | 0.2 | 0.2 | 0.2 |
| CeO₂ (mass %) | 0.5 | 0.6 | 0.5 | 0.6 |
| Sb₂O₃ (mass %) | 0.2 | 0.2 | 0.2 | 0.2 |
| (MgO + ZnO)/ | 0.58 | 0.71 | 0.76 | 0.69 |
| (SrO + BaO + CaO) | | | | |
| Na₂O (mol %)/R₂O | 0.18 | 0.19 | 0.18 | 0.19 |
| K₂O (mol %)/R₂O | 0.52 | 0.52 | 0.52 | 0.52 |
| Li₂O (mol %)/R₂O | 0.29 | 0.29 | 0.30 | 0.29 |
| Specific | 3.0158 | 3.0617 | 3.0923 | 3.1027 |
| gravity (g/cm³) | | | | |
| Linear | 38.7 | 40.8 | 42.0 | 42.4 |
| absorption | | | | |
| coefficient of | | | | |
| X-rays with a | | | | |
| wavelength of | | | | |
| 0.06 nm (cm⁻¹) | | | | |
| Relative degree | 0.84 | 0.81 | 0.67 | 0.81 |
| of browning | | | | |
| Gob temperature | 977 | 963 | 965 | 955 |
| (° C.) when the | | | | |
| glass viscosity | | | | |
| was 10^{2.7} (Pa · S) | | | | |
| Devitrification | Not | Not | 876 | 918 |
| temperature | devitrified | devitrified | | |
| (° C.) | | | | |
| Gob | >150 | >150 | 89 | 37 |
| temperature- | | | | |
| devitrification | | | | |
| temperature | | | | |
| (° C.) | | | | |

TABLE 3

| | Sample No. (Examples) | | | | |
|---|---|---|---|---|---|
| | 5 | 6 | 7 | 8 | |
| SiO₂(mass %) | 57.5 | 56.1 | 56.3 | 46.9 | 55.1 |
| Al₂O₃(mass %) | 2.2 | 0.4 | 0.1 | 1.7 | 1.0 |
| MgO(mass %) | — | — | — | 1.7 | 1.0 |
| CaO(mass %) | — | — | — | — | 1.0 |
| SrO(mass %) | 9.5 | 7.6 | 9.0 | 7.6 | 12.0 |
| BaO(mass %) | 12.8 | 13.7 | 9.0 | 12.6 | 7.0 |
| ZnO(mass %) | 1.1 | 6.7 | 10.0 | 15.6 | 9.0 |
| Na₂O(mass %) | 3.5 | 3.1 | 3.5 | 2.1 | 1.3 |
| K₂O(mass %) | 8.7 | 8.5 | 10.8 | 8.8 | 9.9 |
| Li₂O(mass %) | 0.9 | 1.4 | 0.6 | 1.6 | 2.5 |
| ZrO₂(mass %) | 2.1 | 1.5 | 0.2 | 0.5 | — |
| TiO₂(mass %) | 0.4 | 0.3 | 0.2 | 0.2 | 0.1 |
| CeO₂(mass %) | 0.5 | 0.5 | 0.2 | 0.5 | 0.1 |
| Sb₂O₃(mass %) | 0.6 | 0.2 | 0.1 | 0.2 | — |
| (MgO + ZnO)/ | 0.05 | 0.41 | 0.56 | 0.73 | 0.49 |
| (SrO + BaO + CaO) | | | | | |
| Na₂O(mol %)/R₂O | 0.31 | 0.27 | 0.30 | 0.19 | 0.10 |
| K₂O(mol %)/R₂O | 0.52 | 0.47 | 0.60 | 0.51 | 0.50 |
| Li₂O(mol %)/R₂O | 0.17 | 0.26 | 0.10 | 0.30 | 0.40 |
| Specific | 2.9069 | 2.9755 | 2.9266 | 3.1577 | 2.9562 |
| gravity (g/cm³) | | | | | |
| Linear | 35.5 | 37.4 | 37.0 | 44.3 | 40.1 |
| absorption | | | | | |
| coefficient of | | | | | |
| X-rays with a | | | | | |
| wavelength of | | | | | |
| 0.06 nm (cm⁻¹) | | | | | |
| Relative degree | 1.61 | 1.00 | 1.28 | 0.75 | 1.00 |
| of browning | | | | | |
| Gob temperature | 1027 | 992 | 1009 | 934 | 938 |
| (° C.) when the | | | | | |
| glass viscosity | | | | | |
| was 10^{2.7} (Pa · S) | | | | | |
| Devitrification | 874 | 846 | Not | 964 | 908 |
| temperature | | | devitrified | | |
| (° C.) | | | | | |
| Gob | 153 | 146 | >150 | −30 | 30 |
| temperature- | | | | | |
| devitrification | | | | | |
| temperature | | | | | |
| (° C.) | | | | | |

It is evident from Table 2 that as compared with Sample No. 6 i.e. a known glass composition, with Samples Nos. 1. to 4 i.e. glasses of the present invention, the relative degree of browning is lower by from 16 to 33%, thus indicating less susceptible to browning by electron beams. Further, with each of Sample Nos. 1 to 4, the difference between the gob temperature and the devitrification temperature is larger than 30° C., thus indicating that each of them is suitable for suppressing the devitrification.

Whereas, with Sample Nos. 6 and 9 i.e. glasses of Comparative Examples, the content of bivalent metal oxides having large electronegativity, is not proper, i.e. the value of (MgO+ZnO)/((SrO+BaO+CaO) is smaller than 0.55. Further, the content ratio of an alkali oxide (Na₂O(mol %)/R₂O or K₂O(mol %)R₂O) is outside the proper range, whereby the relative degree of browning was at the same level (1.00) as the prior art, and the property of browning by electron beams was inferior to Samples Nos. 1 to 4 obtained by the present invention.

Further, Sample No. 5 (Comparative Example) wherein (MgO+ZnO)/(SrO+BaO+CaO) was very small at a level of 0.05, was found to be susceptible to browning by electron beams.

In Comparative Example No. 7, the value of (MgO+ZnO)/(SrO+BaO+CaO) was 0.56, but the content ratio of an alkali oxide (Na₂O(mol %)/R₂O, or K₂O(mol %)/R₂O), was outside the proper range, whereby the property of browning was inferior at 1.28 as compared with Samples Nos. 1 to 4 i.e. the glasses of the present invention.

In Comparative Example No. 8, the content of ZnO was too much at a level of 15.6 mass %, whereby the devitrification temperature was higher than the gob temperature, and thus, it is susceptible to devitrification, such being not practical.

The entire disclosure of Japanese Patent Application No. 2003-411247 filed on Dec. 10, 2003 including specification, claims and summary are incorporated herein by reference in its entirety.

1. A panel glass for cathode ray tube, having a glass composition containing substantially no PbO, wherein the contents of the respective components based on their oxides, as represented by mass percentage, are:
```
48 ≦ SiO₂ (mass %) ≦ 60,
  0 ≦ Al₂O₃ (mass %) ≦ 2.5,
  0 ≦ MgO (mass %) 2,
  0 ≦ CaO (mass %) ≦ 3,
  7 ≦ SrO (mass %) ≦ 10,
10 ≦ BaO (mass %) ≦ 15,
10 ≦ ZnO (mass %) ≦ 15,
  1 ≦ Na₂O (mass %) ≦ 5,
  7 ≦ K₂O (mass %) ≦ 11,
0.5 ≦ Li₂O (mass %) ≦ 3,
  0 ≦ ZrO₂ (mass %) ≦ 2.5,
  0 ≦ TiO₂ (mass %) ≦ 2,
  0 ≦ CeO₂ (mass %) ≦ 1,
  0 ≦ Sb₂O₃ (mass %) ≦ 0.5, and
```
(MgO (mass %)+ZnO (mass %))/(SrO (mass %)+BaO(mass %)+CaO (mass %))>0.55, and wherein when the sum of Na₂O (mol %), K₂O (mol %) and Li₂O (mol %), as represented by mol percentage, is represented by R₂O, 0.15≦Na₂O (mol %)/R₂O≦0.25, and 0.45≦K₂O (mol %)/R₂O≦0.55, and
the linear absorption coefficient of X-ray having a wavelength of 0.06 nm is at least 36.0 cm⁻¹.

2. The panel glass for cathode ray tube according to claim 1, wherein the content of ZnO, i.e. ZnO (mass %), is 11≦ZnO (mass %).

3. The panel glass for cathode ray tube according to claim 1, wherein (MgO (mass %)+ZnO (mass %))/(SrO (mass %)+BaO(mass %)+CaO (mass %))≧0.58.

4. The panel glass for cathode ray tube according to claim 1, wherein 0.17≦Na₂O (mol %)/R₂O≦0.22, and 0.48≦K₂O (mol %)/R₂O≦0.54.
